(19) United States
(12) Patent Application Publication
(10) Pub. No.: US 2009/0113143 A1
(43) Pub. Date: Apr. 30, 2009

(54) SYSTEMS AND METHODS FOR MANAGING LOCAL AND REMOTE MEMORY ACCESS

(75) Inventors: Matthew Lee Domsch, Austin, TX (US); Robert L. Winter, Leander, TX (US); Travis L. Hart, JR., Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/925,212

(22) Filed: Oct. 26, 2007

(51) Int. Cl. G06F 12/00

(52) U.S. Cl. 711/154; 711/E12.001

(57) ABSTRACT

A memory management unit (MMU) in an information handling system includes a translation module operable to receive a memory request identifying a memory address, and determine whether the identified memory address corresponds to a local memory resource associated with the information handling system or a remote memory resource coupled to the information handling system via a network. The MMU also includes at least one local memory access module operable to facilitate access to local memory resources if the memory address corresponds to a local memory resource, and at least one remote memory access module operable to facilitate access to remote memory resources via the network if the memory address corresponds to a remote memory resource.

### TECHNICAL FIELD

The present disclosure relates in general to managing memory access, and more particularly to a system and method for managing both local and remote memory access using a memory management unit (MMU).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Virtualization of information handling system resources or components is a continuing trend in the industry. When resources or components are virtualized, they are used by information handling system(s) without knowledge or regard to their physical location or configuration. In recent years, storage resources, computing resources, and network resources have been virtualized to various degrees, thus allowing the use of such resources regardless of their physical location.

However, memory resources (e.g., silicon-based memory such as RAM and ROM, as well as disk-based storage used as memory) have generally not been virtualized to the same extent as other types of resources. Such memory resources are typically bound to their respective physical systems, physically tied to the computing resources of their respective physical systems.

In conventional systems, local memory access and remote memory access are handled separately. Local memory access is typically managed by a memory management unit (MMU), while remote memory access is typically managed by a separate network interface that encapsulates memory requests into various protocols that implement Remote Direct Memory Access (RDMA). For example, in some conventional systems, a network interface (separate from the MMU) accesses remote memory access using iWARP protocols, defined as RDMA over a TCP/IP transport mechanism. This network interface may be referred to as an iWARP network adaptor. In such systems, remote memory access requests are routed around the system resident MMU and to the iWARP network adaptor, for communication through the network. The result is that the remote memory services are typically inconsistent with the services provided by the onboard MMU.

### SUMMARY

In accordance with the teachings of the present disclosure, disadvantages and problems associated with managing both local and remote memory resources for an information handling system have been reduced or eliminated.

In accordance with one embodiment of the present disclosure, a memory management unit (MMU) in an information handling system includes a translation module operable to receive a memory request identifying a memory address, and determine whether the identified memory address corresponds to a local memory resource associated with the information handling system or a remote memory resource coupled to the information handling system via a network. The MMU also includes at least one local memory access module operable to facilitate access to local memory resources if the memory address corresponds to a local memory resource, and at least one remote memory access module operable to facilitate access to remote memory resources via the network if the memory address corresponds to a remote memory resource.

In accordance with another embodiment of the present disclosure, a method for managing requests for memory includes receiving a memory request at a memory management unit (MMU) associated with an information handling system, the memory request identifying a memory address. The method further includes the MMU determining whether the memory address identified in the memory request corresponds to a local memory resource associated with the information handling system or a remote memory resource coupled to the information handling system via a network. If the memory address corresponds to a local memory resource, the MMU manages access to the local memory resource to fulfill the memory request. If the memory address corresponds to a remote memory resource, the MMU manages access to the remote memory resource via the network to fulfill the memory request.

In accordance with a further embodiment of the present disclosure, an information handling system includes an operating system and a memory management unit (MMU). The MMU includes a translation module operable to maintain a translation table corresponding different memory address ranges with local and remote memory resources, receive a memory request from the operating system that identifies a memory address, and use the translation table to determine whether the identified memory address corresponds to a local memory resource associated with the information handling system or a remote memory resource coupled to the information handling system via a network. The MMU further includes at least one remote memory access module operable to facilitate access to remote memory resources via the network if the memory address corresponds to a remote memory resource.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for managing both local and remote memory resources using a memory management unit, according to an embodiment of the disclosure;

FIG. 2 illustrates an example translation table used by a translation module of a network memory management unit (NMMU) for mapping memory requests for local and remote memory resource, according to an embodiment of the present disclosure;

FIG. 3 illustrates a layered stack of components and protocols provided by an NMMU for managing remote memory requests, according to certain embodiments of the present disclosure; and

FIG. 4 is a flowchart illustrating an example method for managing both remote and local memory resources using an NMMU, according to certain embodiments of the present disclosure.

### DETAILED DESCRIPTION

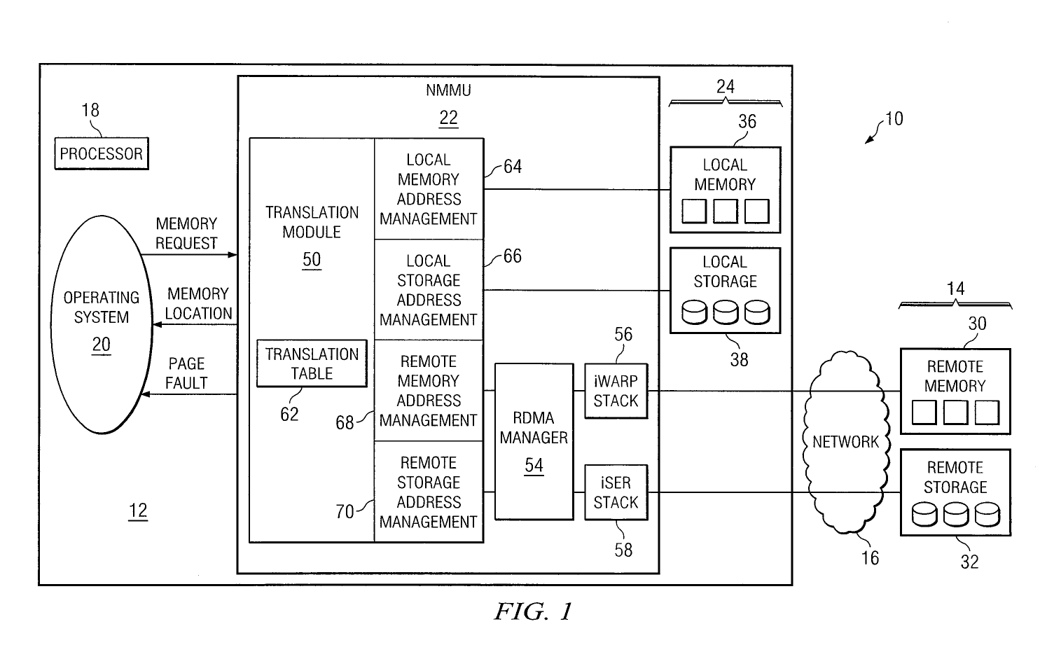

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

Also, for the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a system 10 for managing both local and remote memory resources using a memory management unit, according to an embodiment of the disclosure. System 10 includes an information handling system 12 communicatively coupled to remote memory resources 14 by one or more networks 16. Information handling system 12 includes a processor 18, an operating system 20, a memory management unit 22, and local memory resources 24.

A memory management unit (MMU), sometimes referred to as paged memory management unit (PMMU), is a computer hardware component responsible for managing access to requests (e.g., by a CPU) for memory resources. Conventional MMUs manage accesses to local resources. In contrast, MMU 22 shown in FIG. 1 is operable to manage access to both local memory resources 24 and remote memory resources 14, as discussed in greater detail below. Thus, for simplicity, MMU 22 is referred to hereinafter as network MMU 22, or NMMU 22. In some embodiments, NMMU 22 is a single silicon chip or integrated circuit.

Remote memory resources 14 and local memory resources 24 may include any number and type of memory resources operable to store electronic data. For the purposes of this disclosure, “memory resources” may include any system, device, or apparatus operable to retain program instructions or other data for a period of time (e.g., computer-readable media). Memory resources may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to the relevant information handling system is turned off.

In addition, in some embodiments, memory resources may include an array of storage resources. The array of storage resources may include a plurality of storage resources, and may be operable to perform one or more input and/or output storage operations, and/or may be structured to provide redundancy. In operation, one or more storage resources disposed in an array of storage resources may appear to an operating system as a single logical storage unit or “logical unit.”

In certain embodiments, an array of storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity checking. As known in the art, RAIDs may be implemented according to numerous RAID standards, including without limitation, RAID 0, RAID 1, RAID 0+1, RAID 3, RAID 4, RAID 5, RAID 6, RAID 01, RAID 03, RAID 10, RAID 30, RAID 50, RAID 51, RAID 53, RAID 60, RAID 100, and/or others.

As shown in the example embodiment of FIG. 1, remote memory resources 14 may include remote memory 30 and/or remote storage 32, and local memory resources 24 may include local memory 36 and/or local storage 38. Remote memory 30 and/or local memory 36 may include silicon-based memory resources, such as random access memory (RAM), electrically erasable programmable read-only memory (EEPROM), and flash memory, for example. Remote storage 32 and/or local storage 38 may include disk-based storage resources, such as magnetic storage, opto-magnetic storage, or any other type of disk-based storage. In some embodiments, all or portions of such storage resources may be implemented as RAID storage, e.g., as described above.

In the illustrated embodiment, local memory resources 14 (including local memory 36 and/or local storage 38) are integral with or otherwise associated with information handling system 12. Remote memory resources 14 (including remote memory 30 and/or remote storage 32) are remotely accessible to information handling system 12 via one or more networks 16. For example, remote memory resources 14 may include the memory resources (e.g., remote memory 30 and/or remote storage 32) of one or more information handling systems coupled to information handling system 12 via one or more networks 16.

Although the example embodiment of FIG. 1 shows remote memory resources 14 as including remote memory 30 and remote storage 32, and local memory resources 24 as including local memory 36 and local storage 38, it should be understood that remote memory resources 14 and local memory resources 24 may include any other types or configurations of memory resources.

processor 18 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 104 may interpret and/or execute program instructions and/or process data stored in memory resources 14 and/or 24.

Operating system 20 may include any type of operating system for information handling system 12, e.g., a WINDOWS, LINUX, or UNIX operating system. In some embodiments, information handling system 12 may include multiple different operating systems 20.

Networks 16 may include any one or more networks and/or fabric configured to couple information handling system 12 with remote memory resources 14. A network 16 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data), or any combination thereof. A network 16 may transmit data using wireless transmissions and/or wire-line transmissions via any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof. A network 16 and its various components may be implemented using hardware, software, or any combination thereof.

As mentioned above, NMMU 22 is operable to manage access to both local memory resources 24 and remote memory resources 14. As shown in FIG. 1, NMMU 22 may include a translation module 50, a set of address management modules 52, a Remote Direct Memory Access (RDMA) manager 54, an iWARP protocol stack 56, and an iSER protocol stack 58.

Translation module 50 generally manages high-level mapping of memory requests received, e.g., from operating system 20. In the illustrated embodiment, translation module 50 maintains a translation table 62 for mapping memory addresses to physical memory locations of both local memory resources 14 (including local memory 36 and local storage 38) and remote memory resources 14 (including remote memory 30 and remote storage 32).

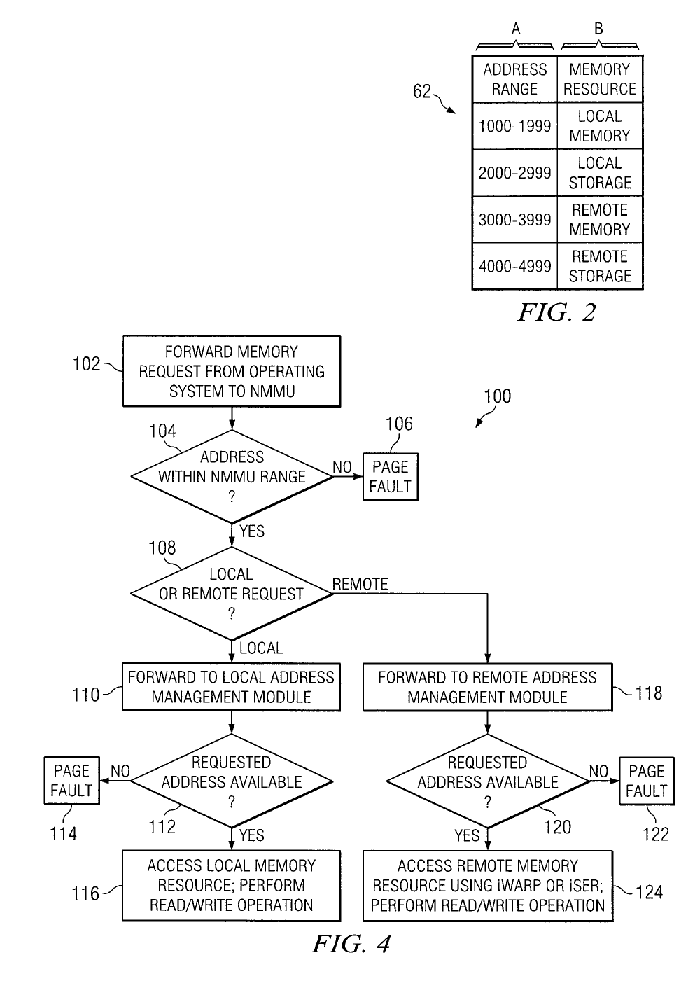

FIG. 2 illustrates an example translation table 62 used by translation module 50 of NMMU 22 for mapping memory requests for local and remote memory resource, according to an embodiment of the present disclosure. Translation table 62 may identify a range of memory addresses for each type of memory resource managed by NMMU 22. In the illustrated example, column A indicates a range of addresses corresponding to a particular type of memory resource and column B indicates the particular type of memory resource. Thus, in this example, translation table 62 includes memory addresses 1,000-4,999, where:

addresses 1,000-1,999 correspond to local memory 36;

addresses 2,000-2,999 correspond to local storage 38;

addresses 3,000-3,999 correspond to remote memory 30; and

addresses 4,000-4,999 correspond to remote storage 32.

In general, translation module 50 receives a memory request that identifies a particular memory address; uses translation table 62 to determine the range in which the requested memory address falls; and forwards the memory request to an address management module 52 corresponding to the identified address range, as discussed below.

Returning to FIG. 1, address management modules 52 provided on NMMU 22 may include a local memory address management module 64, a local disk address management 66, a remote memory address management module 68, and a remote disk address management 70. Each address management modules 52 is generally operable to manage the memory range for the corresponding memory resource type. Thus, local memory address management module 64 manages the memory address range for local memory 36; local disk address management 66 manages the memory address range for local storage 38; remote memory address management module 68 manages the memory address range for remote memory 30; and remote disk address management 70 manages the memory address range for remote storage 32. Such management of memory addresses may include, e.g., allocating and re-allocating memory and/or keeping track of which memory is used or available. In some embodiments, each address management modules 52 may maintain or manage one or more memory address tables for providing such management functionality.

Each address management modules 52 is configured to receive a memory request forwarded from translation module 50, determine whether the requested memory address is currently available, and proceed accordingly. For example, if the requested memory address is available, the address management module 52 may forward the memory request to the corresponding memory resource 14 or 24, and if the requested memory address is not available, the address management module 52 may return a “page fault” or other response to the requesting operating system 20.

RDMA manager 54 manages the forwarding of RDMA requests received from address management modules 52 to remote memory resources 14. In other words, RDMA manager 54 may issue commands or requests to read and/or write data to remote memory resources 14 using RDMA protocols. RDMA manager 54 may manage or request the wrapping or encapsulation of remote memory requests using iWARP, iSER, or other suitable wrapping or transport protocols. For example, RDMA manager 54 may utilize iWARP protocol stack 56 for wrapping/transporting memory requests for remote memory 30 (e.g., RAM) and iSER protocol stack 58 for wrapping/transporting memory requests for remote storage (e.g., disk storage) 32.

To illustrate the operation of NMMU 22 with respect to a remote memory request (i.e., a memory request for a remote memory resource 14), suppose operating system 20 forwards a memory request for memory addresses 3,500-3,510 to translation module 62. Translation module 62 may then access translation table 50 and to identify that the requested address range falls within the 3,000-3,999 range, which corresponds to remote memory 30. Translation module 62 may then forward the remote memory request to remote memory address management module 68, which may refer to its address table(s) to determine whether the 3,500-3,510 address range is available. If so, remote memory address management module 68 may forward the memory request to (RDMA) manager 54, which may then use iWARP stack 58 for wrapping the memory request and forward the memory request to the appropriate remote memory 30 via network network 16. Alternatively, if the 3,500-3,510 address range is not available, remote memory address management module 68 may return a “page fault” or other message to operating system 20.

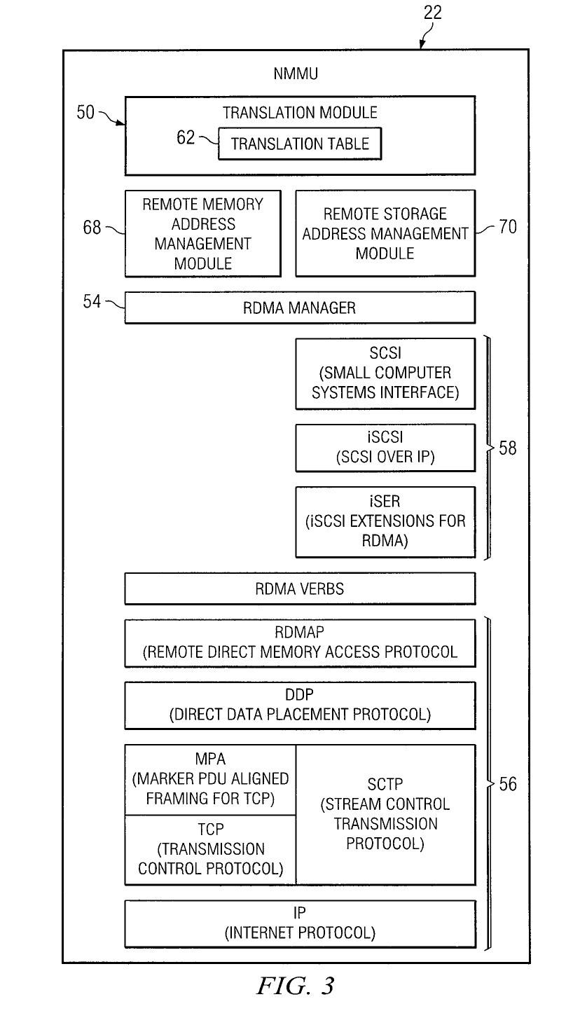

FIG. 3 illustrates a layered stack 130 of components and protocols provided by NMMU 22 for managing remote memory requests, according to certain embodiments of the present disclosure. In general, NMMU 22's management of a memory request for remote memory 30 is indicated by progressing from the top to the bottom of the left side of stack 130. Thus, following down the left side of stack 130, a memory request for remote memory 30 is received by translation module 50, which accesses translation table 62; forwarded to remote memory address management module 68; and forwarded to RDMA manager 54, which forwards the memory request to the appropriate remote memory 30 using iWARP wrapping/transport protocols 56.

Similarly, NMMU 22's management of a memory request for remote storage 32 is indicated by progressing from the top to the bottom of the right side of stack 130. Thus, following down the right side of stack 130, a memory request for remote storage 32 is received by translation module 50, which accesses translation table 62; forwarded to remote storage address management module 70; and forwarded to RDMA manager 54, which forwards the memory request to the appropriate remote storage 32 according to iSER wrapping/transport protocols 58 and/or iWARP wrapping/transport protocols 56.

In other embodiments, NMMU 22 may include any one or more additional or fewer components or protocols for management memory requests for remote memory 30 and/or remote storage 32.

FIG. 4 is a flowchart illustrating an example method 100 for managing both remote and local memory resources 14 and 24 using NMMU 22, according to certain embodiments of the present disclosure.

According to one embodiment, method 100 preferably begins at step 102. As noted above, teachings of the present disclosure may be implemented in a variety of configurations of system 10. As such, the preferred initialization point for method 100 and the order of the steps 102-124 comprising method 100 may depend on the implementation chosen.

At step 102, a memory request is forwarded from operating system 20 to NMMU 22. The memory request identifies a memory address range. At step 104, translation module 50 accesses translation table 62 and determines whether the memory address range identified in the memory request is within the range of addresses managed by translation module 50. If the memory address range identified in the memory request is outside the range of addresses managed by translation module 50, NMMU 22 may send a “page fault” or other similar response back to operating system 20 at step 106.

Alternatively, if the memory address range identified in the memory request is within the range of addresses managed by translation module 50, at step 108, translation module 50 may determine the range in which the requested memory address falls, i.e., translation module 50 may determine whether the requested memory address falls within an addresses range corresponding to a local memory resource 24 (e.g., local memory 36 or local storage 38) or a remote memory resource 14 (e.g., remote memory 30 or remote storage 32).

If translation module 50 determines that the requested memory address falls within an addresses range corresponding to a local memory resource 24, at step 110, translation module 50 may forward the memory request to the appropriate local address management module 52 (e.g., local memory address management module 64 or local disk address management 66). For example, if the requested memory address corresponds to an addresses range for local RAM, translation module 50 may forward the memory request to local memory address management module 64.

At step 112, the memory address management module 52 (local memory address management module 64 or local disk address management 66) that receives the memory request from translation module 50 may determine whether the requested memory address is available (e.g., by referencing tabled maintained by the respective memory address management module 52). If the requested memory address is not available, NMMU 22 may send a “page fault” or other similar response back to operating system 20 at step 114. Alternatively, if the requested memory address is available, at step 116, memory address management module 52 (local memory address management module 64 or local disk address management 66) may access the appropriate local memory resource 24 and perform the requested read/write operation.

Returning to step 108, if translation module 50 determines that the requested memory address falls within an addresses range corresponding to a remote memory resource 14, at step 118, translation module 50 may forward the memory request to the appropriate remote address management module 52 (e.g., remote memory address management module 68 or remote disk address management 70). For example, if the requested memory address corresponds to an addresses range for remote RAM, translation module 50 may forward the memory request to remote memory address management module 68.

At step 120, the memory address management module 52 (remote memory address management module 68 or remote disk address management 70) that receives the remote memory request from translation module 50 may determine whether the requested memory address is available (e.g., by referencing tabled maintained by the respective memory address management module 52). If the requested memory address is not available, NMMU 22 may send a “page fault” or other similar response back to operating system 20 at step 122.

Alternatively, if the requested memory address is available, at step 116, memory address management module 52 (remote memory address management module 68 or remote disk address management 70) may access the appropriate remote memory resource 14 via network 16 and perform the requested read/write operation at step 124. This step may include wrapping the remote memory request according to iWARP and/or iSER wrapping/transport protocols, e.g., as discussed above.

Although FIG. 4 discloses a particular number of steps to be taken with respect to method 100, method 100 may be executed with more or fewer steps than those depicted in FIG. 4. In addition, although FIG. 4 discloses a certain order of steps to be taken with respect to method 100, the steps comprising method 100 may be completed in any suitable order.

Method 100 may be implemented using system 10 or any other system operable to implement method 100. In certain embodiments, method 100 may be implemented partially or fully in software, firmware, or other logic embodied in tangible computer readable media. As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or a physical or virtual storage resource. As discussed above, in certain embodiments, NMMU 22 comprises a silicon chip or integrated circuit.

Using the methods and systems disclosed herein, problems associated conventional approaches to managing both local and remote memory access requests in an information handling system may be reduced or eliminated. For example, providing an NMMU with the functionality to manage both local and remote memory requests reduces the complexity and/or cost of the system, as multiple devices (e.g., a conventional MMU and separate iWARP network adaptor) may be replaced with a single NMMU device. In some embodiments, performance and/or efficiency may be increased, as the NMMU (e.g., an all-silicon NMMU) may provide a cleaner interface. Further, in some embodiments or configurations, the amount of equipment in a data center may be reduced, as remote memory resources may be used in place of local memory resources. Various embodiments may provide none, some, or all of these advantages, as well as other advantages.

Although the present disclosure has been described in detail, it should be understood that various changes, substitutions, and alterations can be made hereto without departing from the spirit and the scope of the invention as defined by the appended claims.

What is claimed is:

1. A memory management unit (MMU) associated with an information handling system, comprising:
a translation module operable to:
receive a memory request identifying a memory address; and
determine whether the identified memory address corresponds to a local memory resource associated with the information handling system or a remote memory resource coupled to the information handling system via a network;
at least one local memory access module operable to facilitate access to local memory resources if the memory address corresponds to a local memory resource; and
at least one remote memory access module operable to facilitate access to remote memory resources via the network if the memory address corresponds to a remote memory resource.

2. A memory management unit (MMU) according to claim 1, wherein the MMU comprises a single silicon chip.

3. A memory management unit (MMU) according to claim 1, wherein:
the local memory access module comprises one of a local memory address management module and a local storage address management module; and
the remote memory access module comprises one of a remote memory address management module and a remote storage address management module.

4. A memory management unit (MMU) according to claim 1, further comprising a Remote Direct Memory Access (RDMA) manager configured to forward the memory request to the remote memory resource.

5. A memory management unit (MMU) according to claim 1, further comprising the Remote Direct Memory Access (RDMA) manager configured to facilitate forwarding of the memory request via the network according to iWARP or iSER protocols.

6. A memory management unit (MMU) according to claim 1, wherein the translation module maintains a translation table that corresponds different memory address ranges with local and remote memory resources.

7. A memory management unit (MMU) according to claim 6, wherein the translation module maintains a translation table that corresponds a first memory address range with local memory, a second memory address range with local storage, a third memory address range with storage memory, and a fourth memory address range with remote storage.

8. A method for managing requests for memory, comprising:
receiving a memory request at a memory management unit (MMU) associated with an information handling system, the memory request identifying a memory address;
the MMU determining whether the memory address identified in the memory request corresponds to a local memory resource associated with the information handling system or a remote memory resource coupled to the information handling system via a network;
if the memory address corresponds to a local memory resource, the MMU managing access to the local memory resource to fulfill the memory request; and
if the memory address corresponds to a remote memory resource, the MMU managing access to the remote memory resource via the network to fulfill the memory request.

9. A method according to claim 8, wherein determining whether the memory address identified in the memory request corresponds to a local memory resource or a remote memory resource comprises accessing a translation table that corresponds different memory address ranges with local and remote memory resources.

10. A method according to claim 8, further comprising if the memory address corresponds to a remote memory resource, forwarding the memory request to a Remote Direct Memory Access (RDMA) manager provided on the MMU.

11. A method according to claim 8, wherein the MMU is operable to manage memory requests for local memory resources and memory requests for remote memory resources.

12. A method according to claim 8, further comprising if the memory address corresponds to a remote memory resource, the MMU using an iWARP or iSER wrapping protocol to wrap the memory request for communication via the network toward the remote memory resource.

13. A method according to claim 8, further comprising:
a translation module associated with the MMU using a translation table to determine whether the memory address corresponds to local memory, local storage, remote memory, or remote storage;
if the memory address corresponds to local memory, forwarding the memory request from the translation module to a local memory address management module provided by the MMU;
if the memory address corresponds to local storage, forwarding the memory request from the translation module to a local storage address management module;
if the memory address corresponds to remote memory, forwarding the memory request from the translation module to a remote memory address management module; and
if the memory address corresponds to remote storage, forwarding the memory request from the translation module to a remote storage address management module.

14. A method according to claim 8, wherein the MMU comprises a single silicon chip.

15. An information handling system, comprising:
an operating system; and
a memory management unit (MMU), comprising:
a translation module operable to:
maintain a translation table corresponding different memory address ranges with local and remote memory resources;
receive a memory request from the operating system, the memory request identifying a memory address; and
use the translation table to determine whether the identified memory address corresponds to a local memory resource associated with the information handling system or a remote memory resource coupled to the information handling system via a network; and
at least one remote memory access module operable to facilitate access to remote memory resources via the network if the memory address corresponds to a remote memory resource.

16. An information handling system according to claim 15, wherein the MMU comprises a single silicon chip.

17. An information handling system according to claim 15, wherein the MMU further comprises a Remote Direct Memory Access (RDMA) manager configured to facilitate forwarding of the memory request to the remote memory resource.

18. An information handling system according to claim 17, wherein the RDMA manager facilitates forwarding of the memory request via the network according to iWARP or iSER protocols.

19. An information handling system according to claim 15, further comprising a network interface configured, if the memory address corresponds to a remote memory resource, to receive the memory request from the MMU for forwarding to the remote resource.

20. An information handling system according to claim 15, wherein the MMU is operable to manage memory requests for local memory resources and memory requests for remote memory resources.
